(19) United States
(12) Patent Application Publication
(10) Pub. No.: US 2006/0243201 A1
(43) Pub. Date: Nov. 2, 2006

(54) Doctor bed

(76) Inventors: Christoph Henninger, Heidenheim (DE); Horst Kaipf, Lauingen (DE); Bernard Fuchs, Rohrbach (AT); Martin Schaubmaier, Rorhbach (AT); Michael Heitzinger, Linz (AT); Rudiger Keinberger, Aigen (AT)

Correspondence Address: TAYLOR & AUST, P.C., 142 SOUTH MAIN STREET, P. O. BOX 560, AVILLA, IN, 46710, US

(21) Appl. No.: 11/413,781

(22) Filed: Apr. 28, 2006

(30) Foreign Application Priority Data
May 2, 2005 (DE) 10 2005 020 848.7

(51) Int. Cl. B05C 5/00

(52) U.S. Cl. 118/325; 118/261

(57) ABSTRACT

A doctor bed formed as a profiled strip having a continuous groove in the axial direction in order to hold a rotatable metering rod, which can be pressed against a moving surface and which meters and/or equalizes liquid to pasty medium applied to the moving surface. The moving surface, in the case of direct application of the medium, being one side of a paper, board or other fibrous web; and in the case of indirect application, being the surface of a transfer element which transfers the application medium to the fibrous web. Also disclosed is, for the production of the doctor bed, a material or a material combination selected including in a first variant of a homogeneous mixture of 70 to 99.8% polyethylene and 0.2 to 30% by weight of a wax of animal, vegetable, mineral or synthetic origin that is solid or liquid at room temperature.

### BACKGROUND OF THE INVENTION

1. Field of the Invention

The present invention relates to a doctor bed formed as a profiled strip having a continuous groove in the axial direction in order to hold a rotatable metering rod, which can be pressed against a moving surface and which meters and/or equalizes liquid to pasty medium applied to the moving surface. The moving surface, in the case of direct application of the medium, being one side of a paper, board or other fibrous web, and in the case of indirect application, being the surface of a transfer element which transfers the application medium to the fibrous web.

2. Description of the Related Art

A doctor bed of a metering, doctoring or equalizing unit is known from diverse documents, for example, reference can be made to DE-A1 3022 955. In this case, the metering rod is held in a doctor bed made of resilient material. However, other homogeneous materials of the doctor bed, such as polyethylene and polyurethane, are also known.

Normally, on its rear facing away from the metering rod, the doctor bed has a pressing element (pressure hose) to press it against the moving surface. By using the pressing element or the pressure hose, the thickness of the metered film on the moving surface can be adjusted and varied via the pressure in the pressure hose. In addition, the doctor bed contains flushing channels, into which a flushing or lubricating liquid, for example water, is introduced. As a result, the mounting of the doctor bed can be lubricated and any application medium which may have penetrated can be diluted and removed.

The smooth or profiled metering rod rotating in the doctor bed effects considerable wear of the doctor bed. The doctor beds, produced with accurate dimensions, therefore have to be replaced frequently, which causes considerable costs and effort.

The wear is all the greater and the frictional relationships become less and less beneficial the more the doctor bed is pressed against the metering rod in the region of its groove accommodating the metering rod, in order firstly to be able to guide the metering rod better over its entire length (machine width) and secondly to be able to prevent the aforesaid penetration of application medium. In this case, an enormously high drive power of the rotating metering rod is then needed, which again causes high costs.

What is needed in the art is a doctor bed that is improved in terms of its frictional relationships and an improved material.

### SUMMARY OF THE INVENTION

The present invention provides a doctor bed wherein materials and material combinations are provided which exhibit a substantially lower coefficient of friction than the materials used hitherto.

According to an embodiment of the present invention a material is proposed which includes a homogeneous mixture of 70 to 99.8% polyethylene and 0.2 to 30% by weight of a wax of animal, vegetable, mineral or synthetic origin that is solid or liquid at room temperature; according to another embodiment of the present invention, a material is proposed which includes a homogeneous mixture of 70 to 99.8% polyethylene and 0.2 to 30% by weight of a grease of animal origin that is solid or liquid at room temperature; and according to another embodiment of the present invention, a material is proposed which includes a homogeneous mixture of 70 to 99.8% polyethylene and 0.2 to 30% by weight of a natural or synthetic oil.

The following waxes, greases or oils (to some extent, their product names are indicated) are suitable for the material combination according to the present invention: lubricant concentrates including hydrocarbon waxes; carboxylic acids and their amides but also carboxylates; to some extent also alcohols, such as HECOSLIP; paraffin waxes, such as AdSperse; Fischer Tropsch waxes; microwaxes, such as petrolatum, EnHance, Sasobit; raw paraffins, such as Rubitherm; vaselines, such as Hellfrisch Vaseline; white oil; silicone oil; wax oils; bitumen additives, such as Scenti; synthetic waxes, such as Hydrowax, Sasolwax; stearins, such as Varacid, VaraNat; natural waxes; and gel waxes, such as VaraGel.

Provision is made for the production of wear-resistant ultra high molecular weight polyethylene (UHMW-PE) according to the present invention to be carried out via sinter pressing. The production operation for doctor beds, for example, assumes stress-free production of the plastic block which, for example, can be achieved by way of appropriate cooling curves. During the compression (to 220 bar) and at the press temperature of 250° C., oils, liquid waxes and liquid greases tend to accumulate locally even at room temperature as compared with solid waxes and greases. Stepwise pressing with specifically different temperature levels prevents the precipitation of liquid. In the melt, homogeneous incorporation of the lubricating additives in finely dispersed form takes place.

In this case, no immediate compression at full temperature is carried out; instead with the press plunger placed without pressure and brief full temperature loading, a molten drawn skin is achieved, in which the interior is still in pure powder form wetted with liquid. Only after that is the pressure increased at lower temperature and the material pressed. A lower temperature is chosen in order to arrange for the liquid not to flow downward too quickly but at the same time to be able to press it finely into the powder (increase in temperature=reduction in viscosity).

The present invention discloses the use of the material combinations according to the present invention, including polyethylene with proportions by weight of waxes or greases or oils, which, in addition to the doctor bed already described of any desired design and shape, can also be used for the production of doctor wiping strips as they are known (one such is described in terms of the arrangement in the subsequently published DE 10 2004 028 754), and also applicator nozzles and edge limiting elements (one such element is described in the subsequently published DE 10 2004 028 755) in an application device, both publications incorporated herein by reference.

In addition, the material combinations described can also be used for supporting elements for the applicator nozzles and metering or doctor units in addition to doctor beds.

The following advantages apply to the doctor beds:
increased service life of the doctor bed;
a lower drive power of the metering rod is required;
a higher pressing force is possible with the same drive power, which denotes that better application profiles in the transverse direction can be achieved;
the possibility of fitting an additional pressing or sealing element within a doctor bed, which denotes that more uniform operating of the metering unit is achieved and deposits in the flushing channels of the doctor bed are reduced and, in the process, the drive power nevertheless does not have to be increased.

It is not necessary for the complete doctor bed to include the material combination according to the present invention; instead, it can be expedient if this particular material is fabricated in the form of an insert part which is inserted section by section and runs in the axial direction, as indicated in the subsequently published DE 10 2004 024 079, incorporated herein by reference. This insert part then exhibits lower friction in relation to the rest (normal material, for example resilient material or PU or PE).

Hitherto, the greases, waxes and oils proposed here have been used only during the production of detergents or specific coating materials. The suitability for forming homogeneous mixtures for the aforementioned components has proven to be surprising, on the other hand, and it is to the credit of the inventors of the present invention to have recognized this.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a partially cross-sectional side view of an embodiment of a doctor bed according to the present invention;

FIG. 2 is a partially cross-sectional side view of an embodiment of an applicator nozzle which is seated on a supporting element according to the present invention;

FIG. 3 is a perspective view of an embodiment of a doctor bed according to the present invention; and

FIG. 4 is a cross-sectional side view of an embodiment of a metering unit with another doctor bed according to the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

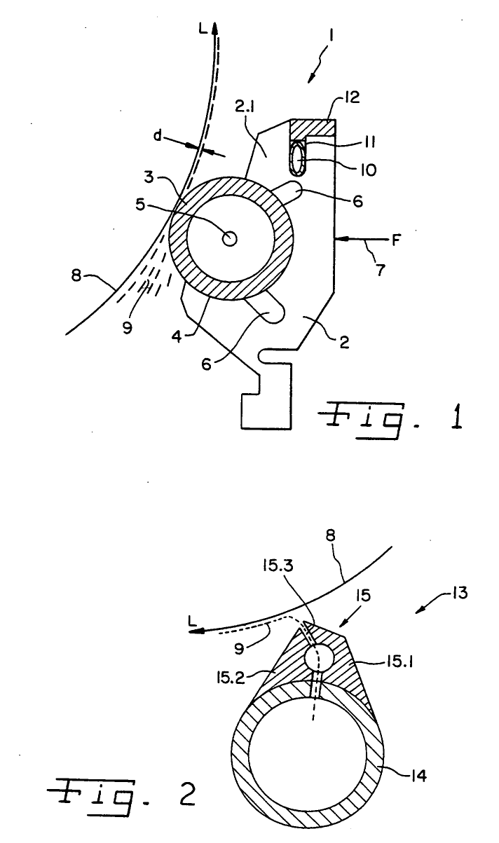

Referring now to the drawings, and more particularly to FIG. 1, there is shown a metering unit 1, which can also be designated a doctoring or equalizing unit 1. It is used for metering, doctoring off or equalizing an application medium previously applied to a moving surface and has a doctor bed 2 according to the present invention and a metering rod 3 as a metering, doctoring or equalizing element. For this purpose, metering rod 3 is accommodated such that it can rotate in a groove 4 running axially, which is matched to the form of the metering rod, and has a rotary drive 5. The more firmly metering rod 3 is held in groove 4, the higher must the drive power normally be. Machined into the doctor bed in the example are two flushing channels 6 that open toward metering rod 3 and into which a flushing liquid can be introduced in order to lubricate rotating metering rod 3 and also to reduce the penetration of application medium into the interior of doctor bed 2.

By using a pressing element 7, doctor bed 2 including metering rod 3 is pressed against a moving surface 8 which in the case of direct application is one side of a fibrous web and in the case of indirect application is the surface of a transfer element which discharges application medium 9 onto the fibrous web, and in the process determines the thickness d of the medium applied. As a rule, a pressure hose is used as pressing element 7, via the adjustable internal pressure of which a pressing force F is set.

According to one embodiment of the present invention, doctor bed 2 is produced from a material combination including a homogeneous mixture of 70 to 99.8% polyethylene and 0.2 to 30% by weight of a wax of animal, vegetable, mineral or synthetic origin that is solid or liquid at room temperature, in particular consisting of long-chain fatty alcohols and fatty acids or carnauba wax and paraffin.

In a second embodiment, doctor bed 2 is produced from a material combination including a homogeneous mixture of 70 to 99.8% polyethylene and 0.2 to 30% by weight of a grease of animal origin that is solid or liquid at room temperature, such as stearins.

In a third embodiment, doctor bed 2 is produced from a material combination including a homogeneous mixture of 70 to 99.8% polyethylene and 0.2 to 30% by weight of a natural or synthetic oil, to which up to 40% by weight of thickeners can be added.

The material combinations selected ensure better frictional relationships than hitherto because of the lower coefficient of friction, so that either the previous drive power can be reduced or an additional pressing element 10 can be accommodated in the doctor bed 2, in a groove 11 in its upper part 2.1, by which elements metering rod 3 is firstly mounted better as a result of this additional pressing and secondly better tightness with respect to penetrating application medium 9 is achieved. This would normally be possible only with an increased drive power of metering rod 3 but this is presently compensated for by using the material proposed in the present invention.

The additional pressing element 10 can be formed as a pressure hose. If the pressure hose is pressurized with air, upper part 2.1 therefore presses against metering rod 3 and the aforementioned advantages are achieved.

Furthermore, a covering strip 12 for the aforesaid pressure hose, that is to say the pressing element or else sealing element 10, can be as shown in FIG. 1. The covering strip is used as a protector for the pressure hose and is screwed to doctor bed 2. In the event of a loss of pressure in pressure hose 10, metering rod 3 is held in groove 4 by covering strip 12 fixed in or on doctor bed 2, so that no undesired ejection of metering rod 3 is possible.

FIG. 2 shows a further exemplary application of the material according to the present invention, that is to say the material combination.

An application device 13 is illustrated, in which an applicator nozzle 15 is placed on a supporting element 14, which is hollow-cylindrical here. Applicator nozzle 15 includes two nozzle lips 15.1 and 15.2 which, between them, form a metering gap 15.3 for applying application medium 9 to surface 8 moving in the running direction L. Both applicator nozzle 15 and supporting element 14 are produced from the material combination according to the present invention and, as a result, guarantee a long service life.

It should also be mentioned that what are known as bounding elements (not illustrated), which are also designated edge limiters or else format limiters, and, as the name already states, define a coating-free edge and a specific format or application width on the moving surface 8 during the production and/or finishing of the latter, can be produced from the material according to the present invention.

It was previously the case that, because of the contact of the bounding element with the rapidly moving surface 8 and the high friction, this element and also the roll cover of the moving surface 8 were partially damaged. By way of the material according to the present invention, the aforementioned disadvantages are reduced considerably and, here too, the service life of the aforesaid components is increased as a result.

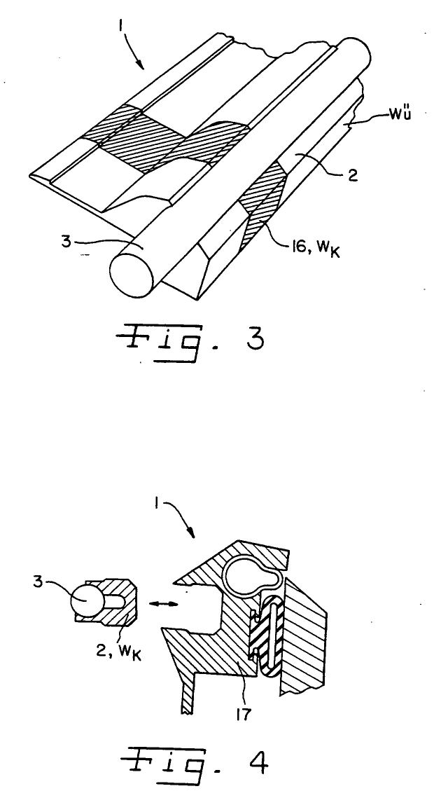

FIG. 3 shows a further exemplary application of the material according to the present invention, that is to say the material combination. This is once more a metering unit 1 with a doctor bed 2 and rotatable metering rod 3 mounted therein. Here, doctor bed 2 does not consist entirely of the material combinations according to the present invention but, as the perspective view shows, includes the material combination Wₖ in the form of an inset part 16 inserted only section by section and running in the axial direction. This inset part 16 can be located in doctor bed 2 so as to be distributed centrally or else to the outer regions or else in a repeated number over the length of the doctor bed 2 and, in relation to the other material Wᵤ (i.e. normal material, for example resilient material or PU or PE), exhibits the advantageous properties described (for example exhibits less friction).

In FIG. 4 it is shown that the doctor bed 2 of a metering unit 1, including or, as described in FIG. 3, at least partly including of material combination Wₖ according to the present invention, can have a form different from that which is shown in FIGS. 1 and 3. It can be seen that doctor bed 2 having the low-friction material has a relatively small cross section in relation to metering rod 3 and is inserted into a relatively large holder 17 such that it can be removed. However, it is also conceivable for holder 17 to be fabricated from the material combination Wₖ.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF DESIGNATIONS

1 Metering unit
2 Doctor bed
2.1 Upper part
3 Metering rod
4 Groove
5 Rotary drive
6 Flushing channel
7 Pressing element
8 Moving surface
9 Application medium
10 Additional pressing element
11 Groove
12 Covering strip
13 Application device
14 Supporting element
15 Applicator nozzle
15.1 Nozzle lip
15.2 Nozzle lip
15.3 Nozzle gap
16 Insert part
17 Holder
F Pressing force
L Running direction
d Thickness
Wₖ Material combination
Wᵤ Other material

What is claimed is:

1. A doctor bed formed as a profiled strip having a continuous groove in the axial direction to hold a rotatable metering rod, which is pressed against a moving surface and which at least one of meters and equalizes liquid to pasty medium applied to the moving surface, the moving surface in the case of direct application of the medium being one side of a fibrous web, and in the case of indirect application being a surface of a transfer element which transfers the medium to the fibrous web, said doctor bed comprising: a material including a homogeneous mixture of approximately between 70% and 99.8% by weight polyethylene, and approximately between 0.2% and 30% by weight of a wax of one of an animal origin, a vegetable origin, a mineral origin and a synthetic origin, said wax is one of solid at room temperature and liquid at room temperature.

2. The doctor bed of claim 1, wherein said fibrous web is one of a paper web and a board web.

3. The doctor bed of claim 1, wherein said wax includes at least one of long-chain fatty alcohols and fatty acids, and carnauba waxes and paraffins.

4. The doctor bed of claim 1, wherein said material has a low coefficient of friction.

5. The doctor bed of claim 1, wherein said material is integrated into said doctor bed as an insert part.

6. The doctor bed of claim 1, further including an additional pressing element being arranged in an upper part of said doctor bed.

7. The doctor bed of claim 6, wherein said additional pressing element is a pressure hose.

8. The doctor bed of claim 6, further including a covering strip being fixed to said doctor bed as a protector for said additional pressing element.

9. A doctor bed formed as a profiled strip having a continuous groove in the axial direction to hold a rotatable metering rod, which is pressed against a moving surface and which at least one of meters and equalizes liquid to pasty medium applied to the moving surface, the moving surface in the case of direct application of the medium being one side of a fibrous web, and in the case of indirect application being a surface of a transfer element which transfers the medium to the fibrous web, said doctor bed comprising: a material including a homogeneous mixture of approximately between 70% and 99.8% by weight polyethylene, and approximately between 0.2% and 30% by weight of a grease of animal origin, said grease is one of solid at room temperature and liquid at room temperature.

10. The doctor bed of claim 9, wherein said fibrous web is one of a paper web and a board web.

11. The doctor bed of claim 9, wherein said grease includes stearins.

12. The doctor bed of claim 9, wherein said material has a low coefficient of friction.

13. The doctor bed of claim 9, wherein said material is integrated into said doctor bed as an insert part.

14. The doctor bed of claim 9, further including an additional pressing element being arranged in an upper part of said doctor bed.

15. The doctor bed of claim 14, wherein said additional pressing element is a pressure hose.

16. The doctor bed of claim 14, further including a covering strip being fixed to said doctor bed as a protector for said additional pressing element.

17. A doctor bed formed as a profiled strip having a continuous groove in the axial direction to hold a rotatable metering rod, which is pressed against a moving surface and which at least one of meters and equalizes liquid to pasty medium applied to the moving surface, the moving surface in the case of direct application of the medium being one side of a fibrous web, and in the case of indirect application being a surface of a transfer element which transfers the medium to the fibrous web, said doctor bed comprising: a material including a homogeneous mixture of approximately between 70% and 99.8% by weight polyethylene, and approximately between 0.2% and 30% by weight of one of a natural oil and a synthetic oil, said oil is one of solid at room temperature and liquid at room temperature.

18. The doctor bed of claim 17, wherein said fibrous web is one of a paper web and a board web.

19. The doctor bed of claim 17, wherein said oil is provided with up to 40% by weight of thickeners.

20. The doctor bed of claim 17, wherein said material has a low coefficient of friction.

21. The doctor bed of claim 17, wherein said material is integrated into said doctor bed as an insert part.

22. The doctor bed of claim 17, further including an additional pressing element being arranged in an upper part of said doctor bed.

23. The doctor bed of claim 22, wherein said additional pressing element is a pressure hose.

24. The doctor bed of claim 22, further including a covering strip being fixed to said doctor bed as a protector for said additional pressing element.

25. A method of production of parts of a metering unit used in a production of a fibrous web, comprising the steps of:
creating a material in a form of a homogeneous mixture of approximately between 70% and 99.8% by weight polyethylene, and approximately between 0.2% and 30% by weight of one of a wax, oil and grease;
forming said metering unit as a profiled strip having a continuous groove in an axial direction in order to hold a rotatable metering rod, which is pressed against a moving surface and acts as a metering element; and
manufacturing at least one of said metering unit, said profiled strip, said continuous groove and said rotatable metering rod using said material.

26. The method of claim 25, wherein said metering unit is a doctor bed.

27. The method of claim 25, further including the step of producing a supporting element for said metering unit using said material.

28. A method of production of parts of an application device for applying one of a liquid medium and a pasty medium to a moving surface, said moving surface in a case of direct application being a surface fibrous web, and in a case of indirect application being a surface of a transfer element which transfers the medium to the fibrous web, comprising the steps of:
creating a material in a form of a homogeneous mixture of approximately between 70% and 99.8% by weight polyethylene, and approximately between 0.2% and 30% by weight of one of a wax, oil and grease;
forming said application device including at least one of an application nozzle and edge elements limiting an application width; and
manufacturing at least one of said application nozzle and said edge elements using said material.

29. The method of claim 28, wherein said fibrous web is one of a paper web and a board web.

30. The method of claim 28, further including the step of producing a supporting element for one of said application device and an application nozzle, using said material.
